(19) United States
(12) Patent Application Publication
(10) Pub. No.: US 2025/0240325 A1
(43) Pub. Date: Jul. 24, 2025

(54) Hyper-customized customer defined machine learning models

(71) Applicant: Zscaler, Inc., San Jose, CA (US)

(72) Inventors: Claudionor Jose Nunes Coelho, JR., Redwood City, CA (US); Yaroslav Rosomakho, Thatcham (GB); Sree Koratala, San Jose, CA (US); Rex Shang, San Jose, CA (US); Hanchen Xiong, London (GB); Matthew Cronin, Nashville, TN (US)

(73) Assignee: Zscaler, Inc., San Jose, CA (US)

(21) Appl. No.: 18/417,534

(22) Filed: Jan. 19, 2024

(51) Int. Cl. H04L 9/40; H04L 41/16

(52) U.S. Cl. CPC H04L 63/20; H04L 41/16

(57) ABSTRACT

Systems and methods for hyper-customized customer defined machine learning models include providing a first set of data obtained based on monitoring a plurality of endpoints by a service provider, wherein the plurality of endpoints are associated with a customer, and wherein the first set of data includes an index; responsive to the customer wanting to create a user-defined machine learning model, receiving a second set of data that maps to a subset of the first set of data based on the index, wherein the second set of data is maintained private from the service provider; receiving a metric from the customer for accepting criteria of the user-defined machine learning model; and determining the user-defined machine learning model based on the first set of data, the second set of data, and the metric.

### FIELD OF THE DISCLOSURE

The present disclosure generally relates to machine learning techniques implemented via a computer. More particularly, the present disclosure relates to systems and methods for hyper-customized customer defined machine learning models.

### BACKGROUND OF THE DISCLOSURE

Machine learning techniques are proliferating and offer many use cases. As is well-known, machine learning, such as supervised machine learning, involves using training data to train a model which can later be used on other data in production for making predictions, inferences, classifications, etc. The training data is key to model performance and there can be situations where the training data is shared by separate organizations or companies.

This is practically the case where there is a cloud provider (or simply a service provider) providing services to multiple organizations or companies. The service provider has a large amount of training data based on ongoing monitoring, and each company can have additional data related to the same set of training data. A simple example includes the service provider having logs indexed to users whereas the company has additional data related to each user. While combining these data is key to maximizing model performance, the sharing of these data may be undesirable or impossible from either the service provider or customer perspective.

Customers are reluctant to share their additional data with the service provider for a variety of reasons. The first reason can simply be privacy and unwillingness to expose personal information related to a company's users to a third party. A second reason could be the company does not want the service provider to create optimal models that can then be used by that company's competitors. Specifically, access to the best data can be strategically valuable to a company and they simply do not want to give away any advantages.

Of course, there can be other reasons as well in that a given company or organization simply does not want to provide proprietary data to a third party, i.e., the service provider, as well as being restricted from doing so based on laws, industry specific regulations, service agreements, or the like. As such, there is a need for two organizations, such as a service provider and customer (i.e., a company or organization) to develop models with both sets of data without the above problems.

### BRIEF SUMMARY OF THE DISCLOSURE

The present disclosure relates to systems and methods for hyper-customized customer defined machine learning models. In particular, the present disclosure enables a customer of a service provider to privately develop customized machine learning models while benefiting from the expertise and economies of scale of the service provider. This is achieved by:
(1) Developing general-purpose feature embeddings or storing features that are extracted or computed from web log data, such as, e.g., accessing known risk sites, time between accesses, etc.
(2) Exposing these to the customer via embedding enriched features.
(3) Allowing the customer to supplement these with additional features derived from data not exposed to the service provider and privately develop task-specific supervised learning solutions.

Systems and methods for hyper-customized customer defined machine learning models include providing a first set of data obtained based on monitoring a plurality of endpoints by a service provider, wherein the plurality of endpoints are associated with a customer, and wherein the first set of data includes an index; responsive to the customer wanting to create a user-defined machine learning model, receiving a second set of data that maps to a subset of the first set of data based on the index, wherein the second set of data is maintained private from the service provider; receiving a metric from the customer for accepting criteria of the user-defined machine learning model; and determining the user-defined machine learning model based on the first set of data, the second set of data, and the metric.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1A is a network diagram of three example network configurations of cybersecurity monitoring and protection of a user.

FIG. 1B is a logical diagram of the cloud operating as a zero-trust platform.

FIG. 2 is a block diagram of a server.

FIG. 3 is a block diagram of a computing device.

FIG. 4 is a flowchart of a process for customer defined machine learning models.

FIG. 5 is a flowchart of another process for customer defined machine learning models.

### DETAILED DESCRIPTION OF THE DISCLOSURE

Again, the present disclosure relates to systems and methods for hyper-customized customer defined machine learning models. In particular, the present disclosure addresses the challenges of developing models based on data from a service provider and from its customers. The techniques described herein address the reluctance of the service provider's customers, allowing them to achieve models, maintaining privacy (i.e., no exposure of the customer's data), maintaining competitive advantages (the model results are only available to the customer thereby not benefiting any competitors), and the like. In an embodiment, the service provider can be a cybersecurity provider, including one providing cybersecurity via the cloud, i.e., security-as-a-service. The present disclosure is described with reference cybersecurity monitoring for illustration purposes, but those skilled in the art will appreciate the techniques described herein can apply to a general service provider (i.e., one providing any service from which the service provider maintains rich log data as well as simply data) and its customers which can use the rich log data with their proprietary data, to develop hyper-customized customer defined machine learning models.

### § 1.0 Cybersecurity Monitoring and Protection Examples

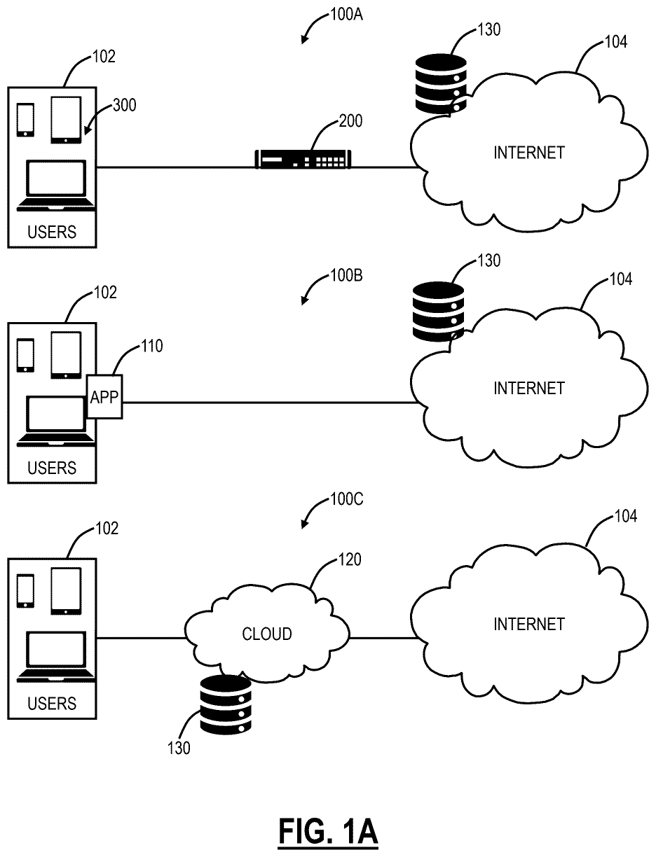

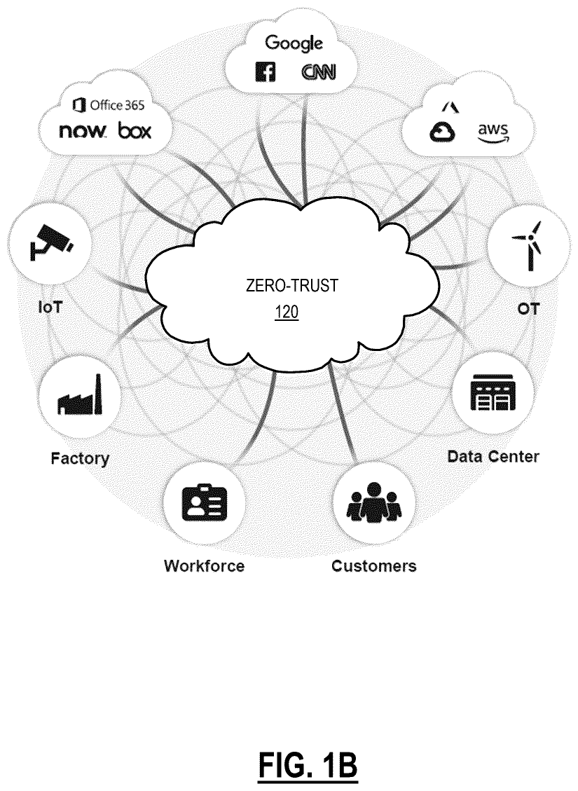

FIG. 1A is a network diagram of three example network configurations 100A, 100B, 100C of cybersecurity monitoring and protection of an endpoint 102. Those skilled in the art will recognize these are some examples for illustration purposes, there may be other approaches to cybersecurity monitoring (as well as providing generalized services), and these various approaches can be used in combination with one another as well as individually. Also, while shown for a single endpoint 102, practical embodiments will handle a large volume of endpoints 102, including multi-tenancy. In this example, the endpoint 102 communicates on the Internet 104, including accessing cloud services, Software-as-a-Service, etc. (each may be offered via computing resources, such as, e.g., using one or more servers 200 as illustrated in FIG. 2).

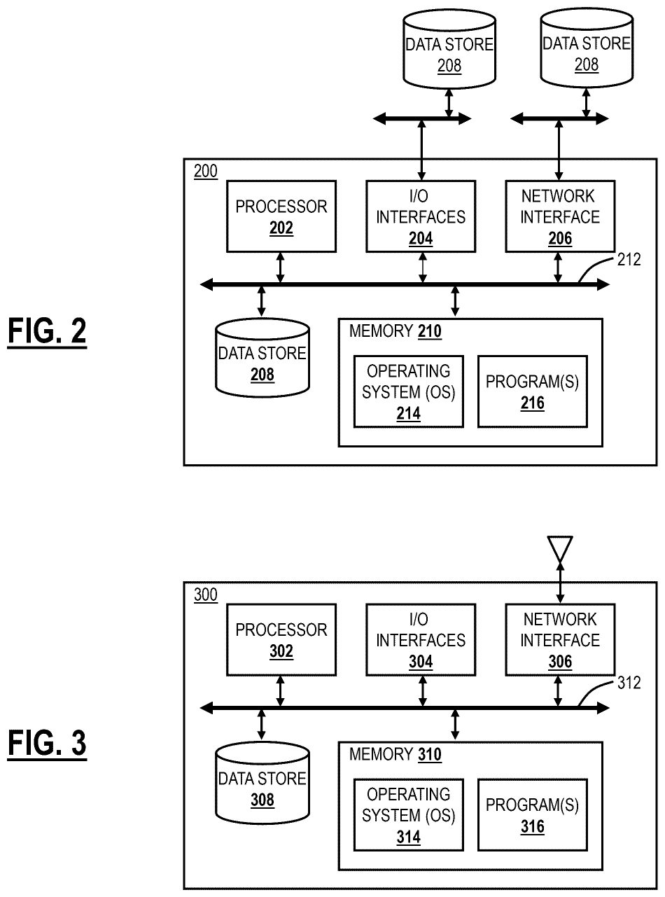

Note, the term endpoint 102 is used herein to refer to any computing device (see FIG. 3 for an example computing device 300) which can communicate on a network. The endpoint 102 can be associated with a user and include laptops, tablets, mobile phones, desktops, etc. Further, the endpoint can also mean machines, workloads, IoT devices, or simply anything associated with the company that connects to the Internet, a Local Area Network (LAN), etc.

As part of offering cybersecurity through these example network configurations 100A, 100B, 100C, there is a large amount of cybersecurity data obtained. The present disclosure focuses on using this cybersecurity data with a customer's proprietary data to develop customer machine learning models.

The network configuration 100A includes a server 200 located between the endpoint 102 and the Internet 104. For example, the server 200 can be a proxy, a gateway, a Secure Web Gateway (SWG), Secure Internet and Web Gateway, Secure Access Service Edge (SASE), Secure Service Edge (SSE), Cloud Application Security Broker (CASB), etc. The server 200 is illustrated located inline with the endpoint 102 and configured to monitor the endpoint 102. In other embodiments, the server 200 does not have to be inline. For example, the server 200 can monitor requests from the endpoint 102 and responses to the endpoint 102 for one or more security purposes, as well as allow, block, warn, and log such requests and responses. The server 200 can be on a local network associated with the endpoint 102 as well as external, such as on the Internet 104. Also, while described as a server 200, this can also be a router, switch, appliance, virtual machine, etc. The network configuration 100B includes an application 110 that is executed on the computing device 300. The application 110 can perform similar functionality as the server 200, as well as coordinated functionality with the server 200 (a combination of the network configurations 100A, 100B). Finally, the network configuration 100C includes a cloud service 120 configured to monitor the endpoint 102 and perform security-as-a-service. Of course, various embodiments are contemplated herein, including combinations of the network configurations 100A, 100B, 100C together.

The cybersecurity monitoring and protection can include firewall, intrusion detection and prevention, Uniform Resource Locator (URL) filtering, content filtering, bandwidth control, Domain Name System (DNS) filtering, protection against advanced threat (malware, spam, Cross-Site Scripting (XSS), phishing, etc.), data protection, sandboxing, antivirus, and any other security technique. Any of these functionalities can be implemented through any of the network configurations 100A, 100B, 100C. A firewall can provide Deep Packet Inspection (DPI) and access controls across various ports and protocols as well as being application and user aware. The URL filtering can block, allow, or limit website access based on policy for a user, group of users, or entire organization, including specific destinations or categories of URLs (e.g., gambling, social media, etc.). The bandwidth control can enforce bandwidth policies and prioritize critical applications such as relative to recreational traffic. DNS filtering can control and block DNS requests against known and malicious destinations.

The intrusion prevention and advanced threat protection can deliver full threat protection against malicious content such as browser exploits, scripts, identified botnets and malware callbacks, etc. The sandbox can block zero-day exploits (just identified) by analyzing unknown files for malicious behavior. The antivirus protection can include antivirus, antispyware, antimalware, etc. protection for the endpoints 102, using signatures sourced and constantly updated. The DNS security can identify and route command-and-control connections to threat detection engines for full content inspection. The DLP can use standard and/or custom dictionaries to continuously monitor the endpoints 102, including compressed and/or Transport Layer Security (TLS) or Secure Sockets Layer (SSL)-encrypted traffic.

In typical embodiments, the network configurations 100A, 100B, 100C can be multi-tenant and can service a large volume of the endpoints 102. Newly discovered threats can be promulgated for all tenants practically instantaneously. The endpoints 102 can be associated with a tenant, which may include an enterprise, a corporation, an organization, etc. That is, a tenant is a group of users who share a common grouping with specific privileges, i.e., a unified group under some IT management. The present disclosure can use the terms tenant, enterprise, organization, enterprise, corporation, company, etc. interchangeably and refer to some group of endpoints 102 under management by an IT group, department, administrator, etc., i.e., some group of endpoints 102 that are managed together. One advantage of multi-tenancy is the visibility of cybersecurity threats across a large number of endpoints 102, across many different organizations, across the globe, etc. This provides a large volume of data to analyze, use machine learning techniques on, develop comparisons, etc. The present disclosure can use the term “service provider” to denote an entity providing the cybersecurity monitoring and a “customer” as a company (or any other grouping of endpoints 102).

Of course, the cybersecurity techniques above are presented as examples. Those skilled in the art will recognize other techniques are also contemplated herewith. That is, any approach to cybersecurity that can be implemented via any of the network configurations 100A, 100B, 100C. Also, any of the network configurations 100A, 100B, 100C can be multi-tenant with each tenant having its own endpoints 102 and configuration, policy, rules, etc.

### § 1.1 Cloud Monitoring

The cloud 120 can scale cybersecurity monitoring and protection with near-zero latency on the endpoints 102. Also, the cloud 120 in the network configuration 100C can be used with or without the application 110 in the network configuration 100B and the server 200 in the network configuration 100A. Logically, the cloud 120 can be viewed as an overlay network between endpoints 102 and the Internet 104 (and cloud services, SaaS, etc.). Previously, the IT deployment model included enterprise resources and applications stored within a data center (i.e., physical devices) behind a firewall (perimeter), accessible by employees, partners, contractors, etc. on-site or remote via Virtual Private Networks (VPNs), etc. The cloud 120 replaces the conventional deployment model. The cloud 120 can be used to implement these services in the cloud without requiring the physical appliances and management thereof by enterprise IT administrators. As an ever-present overlay network, the cloud 120 can provide the same functions as the physical devices and/or appliances regardless of geography or location of the endpoints 102, as well as independent of platform, operating system, network access technique, network access provider, etc.

There are various techniques to forward traffic between the endpoints 102 and the cloud 120. A key aspect of the cloud 120 (as well as the other network configurations 100A, 100B) is that all traffic between the endpoints 102 and the Internet 104 is monitored. All of the various monitoring approaches can include log data 130 accessible by a management system, management service, analytics platform, and the like. For illustration purposes, the log data 130 is shown as a data storage element and those skilled in the art will recognize the various compute platforms described herein can have access to the log data 130 for implementing any of the techniques described herein for risk quantification. In an embodiment, the cloud 120 can be used with the log data 130 from any of the network configurations 100A, 100B, 100C, as well as other data from external sources.

The cloud 120 can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “Software-as-a-Service” (SaaS) is sometimes used to describe application programs offered through cloud computing. A common shorthand for a provided cloud computing service (or even an aggregation of all existing cloud services) is “the cloud.” The cloud 120 contemplates implementation via any approach known in the art.

The cloud 120 can be utilized to provide example cloud services, including Zscaler Internet Access (ZIA), Zscaler Private Access (ZPA), Zscaler Workload Segmentation (ZWS), and/or Zscaler Digital Experience (ZDX), all from Zscaler, Inc. (the assignee and applicant of the present application). Also, there can be multiple different clouds 120, including ones with different architectures and multiple cloud services. The ZIA service can provide the access control, threat prevention, and data protection. ZPA can include access control, microservice segmentation, etc. The ZDX service can provide monitoring of user experience, e.g., Quality of Experience (QoE), Quality of Service (QOS), etc., in a manner that can gain insights based on continuous, inline monitoring. For example, the ZIA service can provide a user with Internet Access, and the ZPA service can provide a user with access to enterprise resources instead of traditional Virtual Private Networks (VPNs), namely ZPA provides Zero Trust Network Access (ZTNA). Those of ordinary skill in the art will recognize various other types of cloud services are also contemplated.

### § 1.2 Zero Trust

FIG. 1B is a logical diagram of the cloud 120 operating as a zero-trust platform. Zero trust is a framework for securing organizations in the cloud and mobile world that asserts that no user or application should be trusted by default. Following a key zero trust principle, least-privileged access, trust is established based on context (e.g., user identity and location, the security posture of the endpoint, the app or service being requested) with policy checks at each step, via the cloud 120. Zero trust is a cybersecurity strategy where security policy is applied based on context established through least-privileged access controls and strict user authentication-not assumed trust. A well-tuned zero trust architecture leads to simpler network infrastructure, a better user experience, and improved cyberthreat defense.

Establishing a zero-trust architecture requires visibility and control over the environment's users and traffic, including that which is encrypted; monitoring and verification of traffic between parts of the environment; and strong multi-factor authentication (MFA) approaches beyond passwords, such as biometrics or one-time codes. This is performed via the cloud 120. Critically, in a zero-trust architecture, a resource's network location is not the biggest factor in its security posture anymore. Instead of rigid network segmentation, your data, workflows, services, and such are protected by software-defined micro segmentation, enabling you to keep them secure anywhere, whether in your data center or in distributed hybrid and multi-cloud environments.

The core concept of zero trust is simple: assume everything is hostile by default. It is a major departure from the network security model built on the centralized data center and secure network perimeter. These network architectures rely on approved IP addresses, ports, and protocols to establish access controls and validate what's trusted inside the network, generally including anybody connecting via remote access VPN. In contrast, a zero-trust approach treats all traffic, even if it is already inside the perimeter, as hostile. For example, workloads are blocked from communicating until they are validated by a set of attributes, such as a fingerprint or identity. Identity-based validation policies result in stronger security that travels with the workload wherever it communicates-in a public cloud, a hybrid environment, a container, or an on-premises network architecture.

Because protection is environment-agnostic, zero trust secures applications and services even if they communicate across network environments, requiring no architectural changes or policy updates. Zero trust securely connects users, devices, and applications using business policies over any network, enabling safe digital transformation. Zero trust is about more than user identity, segmentation, and secure access. It is a strategy upon which to build a cybersecurity ecosystem.

At its core are three tenets:

Terminate every connection: Technologies like firewalls use a “passthrough” approach, inspecting files as they are delivered. If a malicious file is detected, alerts are often too late. An effective zero trust solution terminates every connection to allow an inline proxy architecture to inspect all traffic, including encrypted traffic, in real time—before it reaches its destination—to prevent ransomware, malware, and more.

Protect data using granular context-based policies: Zero trust policies verify access requests and rights based on context, including user identity, device, location, type of content, and the application being requested. Policies are adaptive, so user access privileges are continually reassessed as context changes.

Reduce risk by eliminating the attack surface: With a zero-trust approach, users connect directly to the apps and resources they need, never to networks (see ZTNA). Direct user-to-app and app-to-app connections eliminate the risk of lateral movement and prevent compromised devices from infecting other resources. Plus, users and apps are invisible to the internet, so they cannot be discovered or attacked.

### § 1.3 Log Data

With the cloud 120 as well as any of the network configurations 100A, 100B, 100C, the log data 130 can include a rich set of statistics, logs, history, audit trails, and the like related to various endpoint 102 transactions. Generally, this rich set of data can represent activity by an endpoint 102. This information can be for multiple endpoints 102 of a company, organization, etc., and analyzing this data can provide a wealth of information as well as training data for machine learning models.

The log data 130 can include a large quantity of records used in a backend data store for queries. A record can be a collection of tens of thousands of counters. A counter can be a tuple of an identifier (ID) and value. As described herein, a counter represents some monitored data associated with cybersecurity monitoring. Of note, the log data can be referred to as sparsely populated, namely a large number of counters that are sparsely populated (e.g., tens of thousands of counters or more, and possible orders of magnitude or more of which are empty). For example, a record can be stored every time period (e.g., an hour or any other time interval). There can be millions of active endpoints 102 or more. Examples of the sparsely populated log data can be the Nanolog system from Zscaler, Inc., the applicant.

Also, such data is described in the following:

Commonly-assigned U.S. Pat. No. 8,429,111, issued Apr. 23, 2013, and entitled “Encoding and compression of statistical data,” the contents of which are incorporated herein by reference, describes compression techniques for storing such logs,

Commonly-assigned U.S. Pat. No. 9,760,283, issued Sep. 12, 2017, and entitled “Systems and methods for a memory model for sparsely updated statistics,” the contents of which are incorporated herein by reference, describes techniques to manage sparsely updated statistics utilizing different sets of memory, hashing, memory buckets, and incremental storage, and

Commonly-assigned U.S. patent application Ser. No. 16/851, 161, filed Apr. 17, 2020, and entitled “Systems and methods for efficiently maintaining records in a cloud-based system,” the contents of which are incorporated herein by reference, describes compression of sparsely populated log data.

A key aspect here is that the cybersecurity monitoring is rich and provides a wealth of information to determine various assessments of cybersecurity. In some embodiments, the log data 130 can be referred to as weblogs or the like. Of note, with various cybersecurity monitoring techniques via the network configurations 100A, 100B, 100C, as well as with other network configurations, the log data 130 is a rich repository of endpoint 102 activity. Unlike websites, specific cloud services, application providers, etc., cybersecurity monitoring can log almost all of a user's 102 activity. That is, the log data 130 is not merely confined to specific activity (e.g., a user's 102 social networking activity on a specific site, a user's 102 search requests on a specific search engine, etc.).

### § 2.0 Example Server Architecture

FIG. 2 is a block diagram of a server 200, which may be used as a destination on the Internet, for the network configuration 100A, etc. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 2 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein. Those skilled in the art will recognize the cloud 120 ultimately runs on one or more physical servers 200, virtual machines, etc.

### § 3.0 Example Computing Device Architecture

FIG. 3 is a block diagram of a computing device 300, which may be realize an endpoint 102. Specifically, the computing device 300 can form a device used by one of the endpoints 102, and this may include common devices such as laptops, smartphones, tablets, netbooks, personal digital assistants, cell phones, e-book readers, Internet-of-Things (IoT) devices, servers, desktops, printers, televisions, streaming media devices, storage devices, and the like, i.e., anything that can communicate on a network. The computing device 300 can be a digital device that, in terms of hardware architecture, generally includes a processor 302, I/O interfaces 304, a network interface 306, a data store 308, and memory 310. It should be appreciated by those of ordinary skill in the art that FIG. 3 depicts the computing device 300 in an oversimplified manner, and a practical embodiment may include additional components and suitably configured processing logic to support known or conventional operating features that are not described in detail herein. The components (302, 304, 306, 308, and 302) are communicatively coupled via a local interface 312. The local interface 312 can be, for example, but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the computing device 300, a semiconductor-based microprocessor (in the form of a microchip or chipset), or generally any device for executing software instructions. When the computing device 300 is in operation, the processor 302 is configured to execute software stored within the memory 310, to communicate data to and from the memory 310, and to generally control operations of the computing device 300 pursuant to the software instructions. In an embodiment, the processor 302 may include a mobile-optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a Liquid Crystal Display (LCD), touch screen, and the like.

The network interface 306 enables wireless communication to an external access device or network. Any number of suitable wireless data communication protocols, techniques, or methodologies can be supported by the network interface 306, including any protocols for wireless communication. The data store 308 may be used to store data. The data store 308 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 3, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end-user functionality with the computing device 300. For example, example programs 316 may include, but not limited to, a web browser, social networking applications, streaming media applications, games, mapping and location applications, electronic mail applications, financial applications, and the like. The application 110 can be one of the example programs.

### § 4.0 Machine Learning

The present disclosure relates to using the log data 130 between the service provider and an individual customer. In cybersecurity, use cases for machine learning include, e.g., malware detection, identifying malicious files for further processing such as in a sandbox, user or content risk determination, intrusion detection, behavior analysis and classification, application segmentation, phishing prevention, root cause analysis, DLP, etc. Of course, machine learning is useful in other areas as well, such as, e.g., medicine, criminal justice, financial analysis, weather forecasting, and the like. Any area is contemplated herewith where there is a service provider having the log data 130 along with a customer having additional data.

### § 4.1 Problem-Supervised Learning

Again, the service provider and its customers have overlapping goals regarding machine learning solutions. In cybersecurity, goals can be developing models to detect malicious behavior with the goal of improving the company's security posture. For example, models can be developed to determine the likelihood of malicious behavior (e.g., a user clicking on a phishing link, etc.), to determine the likelihood a particular user may be a threat (e.g., a user may be planning to leave and take sensitive corporate data with them), and the like. Overlapping goals means the service provider and a given customer want a model for addressing these and other cybersecurity tasks, but the customer does not want their data to assist in making the model better for use with one of their competitors. That is, their goals align, but not exactly. Again, see the description in the background outlining the cases where the service provider and customer are unwilling and/or unable to share data with one another.

Supervised machine learning requires us to provide features or inputs (X₁, X₂, . . . , X_{M}, Z₁, Z₂, . . . , Z_{P}) without loss of generality for numerical or categorical data X₁, X₂, . . . , X_{M}, Z₁, Z₂, . . . , Z_{P} and the desired output Y of the system, for model training. As described herein, a first data set X₁, X₂, . . . , X_{M} is associated with the service provider, where M is an integer >1, and a second data set Z₁, Z₂, . . . , Z_{P} is associated with the customer, where P is an integer >1 and M and P do not have to be the same value.

For example, the following table 1 illustrates a data set of N values, N is an integer >1, and N, M, and P do not have to be the same value. Here, there can be various outcomes Y with the corresponding features or inputs, and this can be used to train a model.

| | | | | | | | | |
|---|---|---|---|---|---|---|---|---|
| X₁ | X₂ | . . . | X_{M} | Z₁ | Z₂ | . . . | Z_{P} | Y |

1
2
. . .
N

In order to develop and train a machine learning model, one needs access to all of the features or inputs X₁, X₂, . . . , X_{M}, Z₁, Z₂, . . . , Z_{P} and the desired output Y. Note, the features or inputs X₁, X₂, . . . , X_{M}, Z₁, Z₂, . . . , Z_{P} can be numerical or categorical data. For example, with the log data 130, the features or inputs X₁, X₂, . . . , X_{M} can be vector embeddings derived from extracted features or a combination of embeddings, and other features extracted from weblogs or computed from them.

Again, there are various shortcomings including:

(1) The service provider may not be able to foresee all possible machine learning classifiers or predictions desired by a customer.

(2) The desired output Y may not be accessible to the service provider (e.g., likelihood of user clicking phishing link), or the optimum input features might include data from outside of the cloud 120, the log data 130, etc.

(3) The customer may be unwilling or unable to grant the service provider access to the required data or even the intended function of a solution that they want to develop.

(4) The service provider being unwilling/unable to directly expose data to customers who wish to build own models (hence providing embeddings herein).

### § 4.2 Hyper-Customized Customer Defined Machine Learning Models

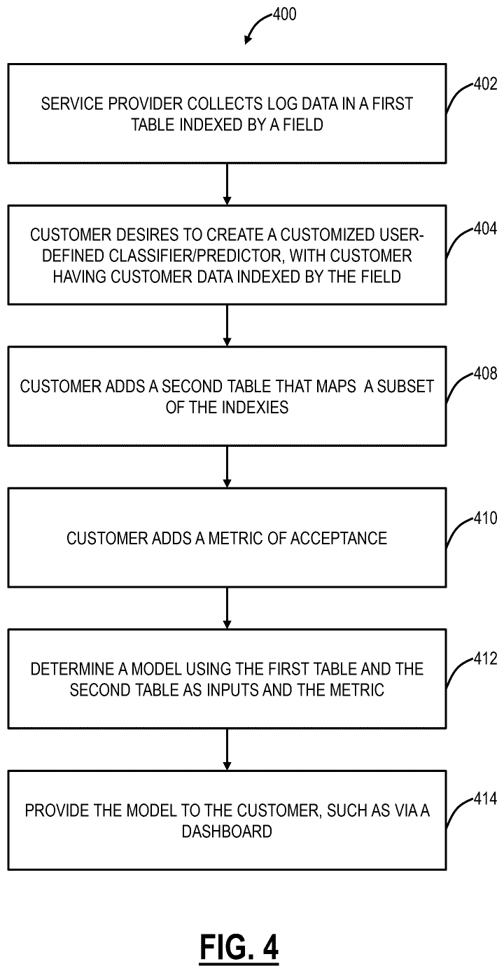

FIG. 4 is a flowchart of a process 400 for customer defined machine learning models. The process 400 contemplates implementation as a computer-implemented method having steps, via a non-transitory computer-readable medium with instructions that cause one or more processors to implement the steps, and via computing resources configured to implement the steps. For example, the computing resources can include the cloud 120, the server 200, the computing device 300, or any other suitable computing resources. The process 400 is described with references to functions performed by both a service provider and a customer. Again, in an embodiment, the service provider can be a cybersecurity provider, and, more particularly, a cloud provider offering Security-as-a-Service. The customer can be one of multiple customers for the service provider. In an embodiment, the process 400 can be implemented through the cloud 120, via a dashboard, and a key aspect is the customer's data, and the end model are excluded from the service provider, i.e., kept private and secure. Further, with respect to the process 400, when referring to the service provider, we refer to data maintained and provided in the course of performing the service, and when we refer to the customer, we refer to an operator, IT administrator, etc. performing the model definition and creation.

The process 400 includes the service provider collecting log data, such as in a first table, indexed by a field (step 402). For example, this can be the log data 130 and each row of the N rows can be a monitored transaction. The index can be one of the fields of the monitored transaction, such as a user identification (ID) field. For example, this first table can look like this:

| | | | | |
|---|---|---|---|---|
| index | X₁ | X₂ | . . . | X_{M} |

1
2
. . .
N

In cybersecurity monitoring, some of the columns of the data X₁, X₂, . . . , X_{M}, can be data from the log data 130, e.g., date/time, user ID, destination address (Uniform Resource Locator (URL), Internet Protocol (IP) address, etc.), information about the computing device 300 (e.g., fingerprinting data), traffic volume, usage patterns, and the like. Some of the columns of the data X₁, X₂, . . . , X_{M}, can be data from external sources. The index is typically the user ID which is something meaningful to the service provider to differentiate the endpoints 102. Of note, the index may give little information to the service provider about the endpoints 102, but rather enable the customer to uniquely identify the endpoint 102. That is, the index can simply be a user ID or some other unique identifier to differentiate endpoints 102.

In an embodiment, if the transactions are weblogs, the service provider can compute a vector representation (embeddings) that enable someone to understand the user's access patterns (it could be as complex as a full graph or as simple as a digraph). For example:

ccoelho; gmail/linkedin/chatgpt/ . . . →[0.3, −0.2, 0.9, . . . ]

The customer desires to create a customized user-defined classifier/predictor, with the customer having customer data indexed by the index (step 404). The customer can add a second table that maps a subset of the indexes (step 408). For example, this second table can look like this:

| | | | | |
|---|---|---|---|---|
| index | Z₁ | . . . | Z_{P} | Y |

1
2
. . .
N′

The second table can have N′ rows and this second table maps a subset N′ (with N′<<N) of the indexes. The columns of the data Z₁, Z₂, . . . , Z_{P}, can be data from the customer, and some or all of the columns of the data Z₁, Z₂, . . . , Z_{P}, can be proprietary data that the customer does not want to share with the service provider, such as personally identifiable information (PII) of the endpoints 102, details of transactions, and the like.

The customer can provide a metric of acceptable, e.g., accepting criteria such as accuracy, f1, etc. (step 410). The process 400 then includes determining a model using the first table, the second table, and the metric as inputs with the outputs Y (step 412). We add a customer specific classifier/prediction (let's call it f (X₁, X₂, . . . , X_{M}, Z₁, Z₂, . . . , Z_{P}), i.e. a predictor that takes as inputs service provider generated X₁, X₂, . . . , X_{M} and private data Z₁, Z₂, . . . , Z_{P}) that tries to if it accepts the criteria, using multiple engine classifications, or we tell customer we could not find any viable model based on the metric

One there is a model, the model, its outputs, or the model and its outputs can be provided to the customer, such as via a dashboard (step 414). Of note, the private data Z₁, Z₂, . . . , Z_{P}, the outputs Y, and the model itself are maintained separate from the service provider, e.g., stored securely and privately. The service provider can offer this model in production solely for use by the customer, using ongoing cybersecurity monitoring data, i.e., the first table, along with the provided second table, to make predictions/classifications for the customer.

Again, this approach includes:
(1) Developing general-purpose feature embeddings at the service provider level. For example, embeddings or vector representations can be provided for the log data 130 to enable the customer to analyze this data later on. The service provider may perform this analysis in an unsupervised manner, without considering a specific application, or in a supervised manner tailored to outcomes Y that are visible to and foreseeable by the service provider.
(2) Exposing these to the customer via embedding-as-a-service feature store.
(3) Allowing the customer to supplement these with additional features derived from data not exposed to the service provider and privately develop task-specific supervised learning solutions.

The process 400 can let customers create customized classifiers/predictions even if the service provider could not envision these solutions. The customer can add information that the service provider does not have access to nor would the service provider have access to the model, the results, etc.

Of note, there is a conventional concept of Federated Learning (also known as collaborative learning) which trains models using different datasets. The present disclosure differs from this approach in that the customer does not share the results of the model with the service provider, even partially.

### § 4.3 Process

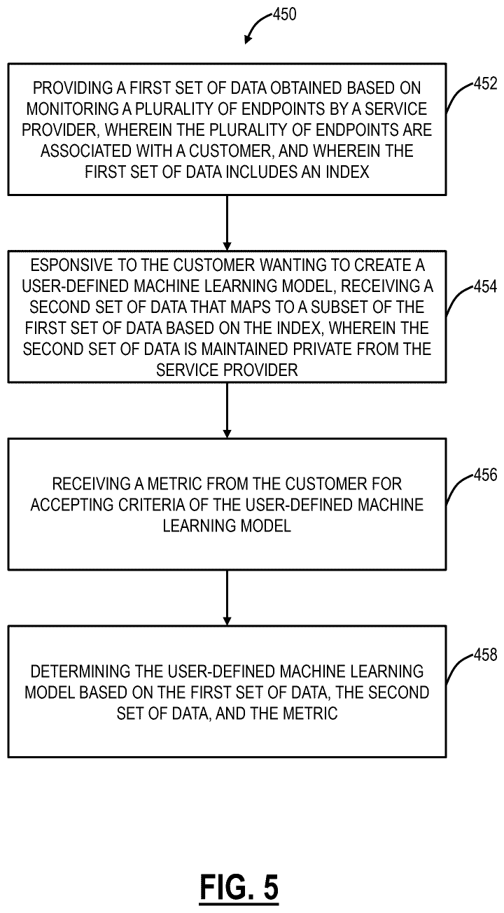

FIG. 5 is a flowchart of a process 450 for customer defined machine learning models. The process 450 contemplates implementation as a computer-implemented method having steps, via a non-transitory computer-readable medium with instructions that cause one or more processors to implement the steps, and via computing resources configured to implement the steps. For example, the computing resources can include the cloud 120, the server 200, the computing device 300, or any other suitable computing resources. Again, in an embodiment, the service provider can be a cybersecurity provider, and, more particularly, a cloud provider offering Security-as-a-Service. The customer can be one of multiple customers for the service provider. In an embodiment, the process 450 can be implemented through the cloud 120, via a dashboard, and a key aspect is the customer's data, and the end model are excluded from the service provider, i.e., kept private and secure. Further, with respect to the process 450, when referring to the service provider, we refer to data maintained and provided in the course of performing the service, and when we refer to the customer, we refer to an operator, IT administrator, etc. performing the model definition and creation.

The process 450 includes providing a first set of data obtained based on monitoring a plurality of endpoints by a service provider, wherein the plurality of endpoints are associated with a customer, and wherein the first set of data includes an index (step 452); responsive to the customer wanting to create a user-defined machine learning model, receiving a second set of data that maps to a subset of the first set of data based on the index, wherein the second set of data is maintained private from the service provider (step 454); receiving a metric from the customer for accepting criteria of the user-defined machine learning model (step 456); and determining the user-defined machine learning model based on the first set of data, the second set of data, and the metric (step 458).

The process 450 can further include hosting the user-defined machine learning model by the service provider to analyze production data to make a prediction based thereon, wherein the hosting and the prediction are maintained private from the service provider. The monitoring the plurality of endpoints can be for cybersecurity, and wherein the prediction relates to an action being taken by an endpoint of the plurality of endpoints. The monitoring the plurality of endpoints can be for cybersecurity, and wherein the prediction relates to whether or not an endpoint of the plurality of endpoints will violate a cybersecurity or data protection policy. The monitoring the plurality of endpoints can be for cybersecurity, and wherein the prediction relates to whether or not an endpoints of the plurality of endpoints will exfiltrate data of the customer. The monitoring the plurality of endpoints can be for cybersecurity, and wherein the process 450 can further include one or more of blocking a transaction, allowing the transaction, and notifying the customer of the transaction, based on the prediction.

The hosting, the second set of data, and the prediction cam be maintained private from the service provider. The monitoring the plurality of endpoints can be for cybersecurity, and wherein the service provider is configured to perform monitoring for a plurality of customers. The first set of data can include features or inputs X₁, X₂, . . . , X_{M} for N transactions and with the index, where M is an integer >1, wherein the second set of data includes features or inputs Z₁, Z₂, . . . , Z_{P} for N′ transactions and with the index, where P is an integer >1 and M and P do not have to be the same value, N′<<N. The determining can find the user-defined machine learning model with inputs X₁, X₂, . . . , X_{M}, Z₁, Z₂, . . . , Z_{P} to achieve outputs Y for the N′ transactions matching the accepting criteria.

### § 4.4 Example Use Cases

Again, in an embodiment, the service provider provides cybersecurity monitoring and the customer can be one of many different customers using the service provider's cybersecurity monitoring. The customer defined machine learning models can be used to make some predictions, classifications, inferences, etc. related to cybersecurity. These predictions, classifications, inferences, etc. would be based on the first table from the service provider and the second table from the customer, with the result and the model being held confidential to the customer. Those skilled in the art can appreciate there can be various use cases, all of which are contemplated herewith.

In an example use case, the hyper-customized customer defined machine learning model can be used to predict some behavior or activity by endpoints 102 of the customer. An example can include whether or not a given user will click on a phishing link. Another example can include whether or not a given user will exfiltrate data (DLP). In all of these cases, the output of the model is a prediction, classification, inference, etc. which can be provided to customer IT for action, as well as for automated remediation, e.g., blocking access, blocking transactions, etc.

For example, the log data 130 or the first set of data can be classified by the customer, e.g.,
user 1—clicked on phishing
user 10—did not click on phishing
user 13—clicked on phishing

The second set of data can include other information from the customer, e.g,.
user 5—works from office A
user 33—works from office B

The present disclosure can create a a classifier based on the user behavior that allows the customer to predict the most suitable office or group assignment for that user (for example).

In the present disclosure, we let the user do the last mile specifying how the classifier will behave, and we will use that to add to train the classifier only, based on a set of embeddings and pre-configured features.

### § 5.0 Conclusion

It will be appreciated that some embodiments described herein may include one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field Programmable Gate Arrays (FPGAs); and the like along with unique stored program instructions (including software and/or firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application-Specific Integrated Circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” “a circuit configured to,” “one or more circuits configured to,” etc. perform a set of operations, steps, methods, processes, algorithms, functions, techniques, etc. on digital and/or analog signals as described herein for the various embodiments.

Moreover, some embodiments may include a non-transitory computer-readable storage medium having computer-readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a Read-Only Memory (ROM), a Programmable Read-Only Memory (PROM), an Erasable Programmable Read-Only Memory (EPROM), an Electrically Erasable Programmable Read-Only Memory (EEPROM), Flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

Although the present disclosure has been illustrated and described herein with reference to embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims. Further, the various elements, operations, steps, methods, processes, algorithms, functions, techniques, modules, circuits, etc. described herein contemplate use in any and all combinations with one another, including individually as well as combinations of less than all of the various elements, operations, steps, methods, processes, algorithms, functions, techniques, modules, circuits, etc.

What is claimed is:

1. A method comprising steps of:
providing a first set of data obtained based on monitoring a plurality of endpoints by a service provider, wherein the plurality of endpoints are associated with a customer, and wherein the first set of data includes an index;
responsive to the customer wanting to create a user-defined machine learning model, receiving a second set of data that maps to a subset of the first set of data based on the index, wherein the second set of data is maintained private from the service provider;
receiving a metric from the customer for accepting criteria of the user-defined machine learning model; and
determining the user-defined machine learning model based on the first set of data, the second set of data, and the metric.

2. The method of claim 1, wherein the steps further include:
hosting the user-defined machine learning model by the service provider to analyze production data to make a prediction based thereon, wherein the hosting and the prediction are maintained private from the service provider.

3. The method of claim 2, wherein the monitoring the plurality of endpoints is for cybersecurity, and wherein the prediction relates to an action being taken by an endpoint of the plurality of endpoints.

4. The method of claim 2, wherein the monitoring the plurality of endpoints is for cybersecurity, and wherein the prediction relates to whether or not an endpoint of the plurality of endpoints will violate a cybersecurity or data protection policy.

5. The method of claim 2, wherein the monitoring the plurality of endpoints is for cybersecurity, and wherein the prediction relates to whether or not an endpoints of the plurality of endpoints will exfiltrate data of the customer.

6. The method of claim 2, wherein the monitoring the plurality of endpoints is for cybersecurity, and wherein the steps further include:
one or more of blocking a transaction, allowing the transaction, and notifying the customer of the transaction, based on the prediction.

7. The method of claim 2, wherein the hosting, the second set of data, and the prediction are maintained private from the service provider.

8. The method of claim 1, wherein the monitoring the plurality of endpoints is for cybersecurity, and wherein the service provider is configured to perform monitoring for a plurality of customers.

9. The method of claim 1, wherein the first set of data includes features or inputs X₁, X₂, . . . , X_{M} for N transactions and with the index, where M is an integer >1,
wherein the second set of data includes features or inputs Z₁, Z₂, . . . , Z_{P} for N′ transactions and with the index, where P is an integer >1 and M and P do not have to be the same value, N′<<N.

10. The method of claim 9, wherein the determining finds the user-defined machine learning model with inputs X₁, X₂, . . . , X_{M}, Z₁, Z₂, . . . , Z_{P} to achieve outputs Y for the N′ transactions matching the accepting criteria.

11. A non-transitory computer-readable medium comprising instructions that, when executed, cause one or more processors to perform steps of:
providing a first set of data obtained based on monitoring a plurality of endpoints by a service provider, wherein the plurality of endpoints are associated with a customer, and wherein the first set of data includes an index;
responsive to the customer wanting to create a user-defined machine learning model, receiving a second set of data that maps to a subset of the first set of data based on the index, wherein the second set of data is maintained private from the service provider;
receiving a metric from the customer for accepting criteria of the user-defined machine learning model; and
determining the user-defined machine learning model based on the first set of data, the second set of data, and the metric.

12. The non-transitory computer-readable medium of claim 11, wherein the steps further include:
hosting the user-defined machine learning model by the service provider to analyze production data to make a prediction based thereon, wherein the hosting and the prediction are maintained private from the service provider.

13. The non-transitory computer-readable medium of claim 12, wherein the monitoring the plurality of endpoints is for cybersecurity, and wherein the prediction relates to an action being taken by an endpoint of the plurality of endpoints.

14. The non-transitory computer-readable medium of claim 12, wherein the monitoring the plurality of endpoints is for cybersecurity, and wherein the prediction relates to whether or not an endpoint of the plurality of endpoints will violate a cybersecurity or data protection policy.

15. The non-transitory computer-readable medium of claim 12, wherein the monitoring the plurality of endpoints is for cybersecurity, and wherein the prediction relates to whether or not an endpoints of the plurality of endpoints will exfiltrate data of the customer.

16. The non-transitory computer-readable medium of claim 12, wherein the monitoring the plurality of endpoints is for cybersecurity, and wherein the steps further include:
one or more of blocking a transaction, allowing the transaction, and notifying the customer of the transaction, based on the prediction.

17. The non-transitory computer-readable medium of claim 12, wherein the hosting, the second set of data, and the prediction are maintained private from the service provider.

18. The non-transitory computer-readable medium of claim 11, wherein the monitoring the plurality of endpoints is for cybersecurity, and wherein the service provider is configured to perform monitoring for a plurality of customers.

19. The non-transitory computer-readable medium of claim 11, wherein the first set of data includes features or inputs X₁, X₂, . . . , X_{M} for N transactions and with the index, where M is an integer >1,
wherein the second set of data includes features or inputs Z₁, Z₂, . . . , Z_{P} for N′ transactions and with the index, where P is an integer >1 and M and P do not have to be the same value, N′<<N.

20. The non-transitory computer-readable medium of claim 19, wherein the determining finds the user-defined machine learning model with inputs X₁, X₂, . . . , X_{M}, Z₁, Z₂, . . . , Z_{P} to achieve outputs Y for the N′ transactions matching the accepting criteria.
